(19) United States
(12) Patent Application Publication
(10) Pub. No.: US 2017/0085543 A1
(43) Pub. Date: Mar. 23, 2017

(54) APPARATUS AND METHOD FOR EXCHANGING ENCRYPTION KEY

(71) Applicant: SAMSUNG SDS CO., LTD., Seoul (KR)

(72) Inventors: Kyu-Young CHOI, Seoul (KR); Seon-Young LEE, Seoul (KR); Ki-Young KIM, Seoul (KR); Ji-Hoon CHO, Seoul (KR)

(73) Assignee: SAMSUNG SDS CO., LTD., Seoul (KR)

(21) Appl. No.: 15/140,632

(22) Filed: Apr. 28, 2016

(30) Foreign Application Priority Data
Sep. 23, 2015 (KR) 10-2015-0134849

(51) Int. Cl. H04L 29/06; H04L 9/08

(52) U.S. Cl. CPC H04L 63/061; H04L 63/0435; H04L 9/088; H04L 63/0869

(57) ABSTRACT

Disclosed herein are an apparatus and method for exchanging an encryption key. According to an embodiment of the present disclosure, an encryption key exchange apparatus includes an encryption unit to generate a first Diffie-Hellman value and a first secret key using a first random integer and a public key of a second communication device and to encrypt certification data by a symmetric key cryptography using the first secret key, a transmitter to transmit the first Diffie-Hellman value and the encrypted certification data to the second communication device, a receiver to receive, from the second communication device, a second Diffie-Hellman value generated using a second random integer selected by the second communication device, and an acknowledgement message encrypted by the symmetric key cryptography using a second secret key generated from the second random integer and the first Diffie-Hellman value, and a decryption unit to generate the second secret key using the first random integer and the second Diffie-Hellman value and to decrypt the encrypted acknowledgement message using the generated second secret key.

### CROSS-REFERENCE TO RELATED APPLICATION

This application claims priority to and the benefit of Korean Patent Application No. 10-2015-0134849, filed on Sep. 23, 2015, the disclosure of which is incorporated herein by reference in its entirety.

### BACKGROUND

1. Technical Field

Exemplary embodiments of the present disclosure relate to a technology for exchanging an encryption key for encryption.

2. Description of Related Art

In a conventional public key based encryption algorithm, a key exchange protocol uses a public key algorithm to perform a key exchange and receives encrypted data by the exchanged key using a symmetric key encryption algorithm. Consequently, the key exchange and the data encryption cannot be performed simultaneously and are performed serially, thus having a slow speed problem.

The key exchange using all of the existing public key encryption algorithms is of course performed using a KEM/DEM structure of the public key encryption algorithm as it is. This method has a disadvantage of decreasing a performance due to great complexity which is a characteristic of the public key structure.

### SUMMARY

Embodiments of the present disclosure are directed to providing an apparatus and method for exchanging an encryption key.

According to an embodiment of the present disclosure, an encryption key exchange apparatus includes an encryption unit configured to generate a first Diffie-Hellman value and a first secret key using a first random integer and a public key of a second communication device and to encrypt certification data by a symmetric key cryptography using the first secret key, a transmitter configured to transmit the first Diffie-Hellman value and the encrypted certification data to the second communication device, a receiver configured to receive, from the second communication device, a second Diffie-Hellman value generated using a second random integer selected by the second communication device, and an acknowledgement message encrypted by the symmetric key cryptography using a second secret key generated from the second random integer and the first Diffie-Hellman value, and a decryption unit configured to generate the second secret key using the first random integer and the second Diffie-Hellman value and to decrypt the encrypted acknowledgement message using the generated second secret key.

The encryption unit may generate the first Diffie-Hellman value using the first random integer and generate the first secret key using the first random integer and the public key of the second communication device.

The encrypted acknowledgement message may be encrypted using the second secret key generated using a third Diffie-Hellman value generated from the second random integer and the first Diffie-Hellman value.

The decryption unit may generate the third Diffie-Hellman value using the first random integer and the second Diffie-Hellman value, and generate the second secret key from the third Diffie-Hellman value.

The encryption key exchange apparatus may further include a session key generator configured to verify the legitimacy of the decrypted acknowledgement message and to generate a session key using the first Diffie-Hellman value, the second Diffie-Hellman value, and the third Diffie-Hellman value.

According to an embodiment of the present disclosure, a method for exchanging an encryption key includes generating a first Diffie-Hellman value and a first secret key using a first random integer and a public key of a second communication device, encrypting certification data by a symmetric key cryptography using the first secret key, transmitting the first Diffie-Hellman value and the encrypted certification data to the second communication device, receiving, from the second communication device, a second Diffie-Hellman value generated using a second random integer selected by the second communication device, and an acknowledgement message encrypted by the symmetric key cryptography using a second secret key generated from the second random integer and the first Diffie-Hellman value, generating the second secret key using the first random integer and the second Diffie-Hellman value, and decrypting the encrypted acknowledgement message using the generated second secret key.

The encrypting may include generating the first Diffie-Hellman value using the first random integer, generating the first secret key using the first random integer and the public key of the second communication device, and encrypting the certification data by the symmetric key cryptography using the first secret key.

The encrypted acknowledgement message may be encrypted using the second secret key generated using a third Diffie-Hellman value generated from the second random integer and the first Diffie-Hellman value.

The decrypting may include generating the third Diffie-Hellman value using the first random integer and the second Diffie-Hellman value, generating the second secret key from the third Diffie-Hellman value, and decrypting the encrypted acknowledgement message using the second secret key.

The method for exchanging an encryption key may further include verifying the legitimacy of the decrypted acknowledgement message and generating a session key using the first Diffie-Hellman value, the second Diffie-Hellman value, and the third Diffie-Hellman value.

According to another embodiment of the present disclosure, an encryption key exchange apparatus includes a receiver configured to receive, from a first communication device, a first Diffie-Hellman value generated using a first random integer selected by the first communication device, and an certification data encrypted by a symmetric key cryptography using a first secret key generated from the first random integer and a public key of a second communication device, a decryption unit configured to generate the first secret key from a private key corresponding to the public key and the first Diffie-Hellman value and to decrypt the encrypted certification data using the generated first secret key, a certifier configured to certify the first communication device using the decrypted certification data and to generate an acknowledgement message including the certification result, an encryption unit configured to generate a second Diffie-Hellman value using a second random integer and to generate a second secret key from the second random integer and the first Diffie-Hellman value in order to encrypt the acknowledgement message by the symmetric key cryptography using the generated second secret key, and a transmitter configured to transmit the second Diffie-Hellman value and the encrypted acknowledgement message to the first communication device.

The encryption unit may generate a third Diffie-Hellman value using the second random integer and the first Diffie-Hellman value and generate the second secret key from the third Diffie-Hellman value.

The encryption key exchange apparatus may further include a session key generator configured to generate a session key using the first Diffie-Hellman value, the second Diffie-Hellman value, and the third Diffie-Hellman value.

According to another embodiment of the present disclosure, a method for exchanging an encryption key includes receiving, from a first communication device, a first Diffie-Hellman value generated using a first random integer selected by the first communication device, and an certification data encrypted by a symmetric key cryptography using a first secret key generated from the first random integer and a public key of a second communication device, generating the first secret key from a private key corresponding to the public key and the first Diffie-Hellman value, decrypting the encrypted certification data using the generated first secret key, certifying the first communication device using the decrypted certification data and generating an acknowledgement message including the certification result, generating a second Diffie-Hellman value using a second random integer, generating a second secret key from the second random integer and the first Diffie-Hellman value, encrypting the acknowledgement message by the symmetric key cryptography using the generated second secret key, and transmitting the second Diffie-Hellman value and the encrypted acknowledgement message to the first communication device.

The generating of the second secret key may include generating a third Diffie-Hellman value using the second random integer and the first Diffie-Hellman value, and generating the second secret key from the third Diffie-Hellman value.

The method for exchanging an encryption key may further include generating a session key using the first Diffie-Hellman value, the second Diffie-Hellman value, and the third Diffie-Hellman value.

According to an embodiment of the present disclosure, a computer program stored in a computer-readable recording medium is combined with hardware to perform steps of generating a first Diffie-Hellman value and a first secret key using a first random integer and a public key of a second communication device, encrypting certification data by a symmetric key cryptography using the first secret key, transmitting the first Diffie-Hellman value and the encrypted certification data to the second communication device, receiving, from the second communication device, a second Diffie-Hellman value generated using a second random integer selected by the second communication device, and an acknowledgement message encrypted by the symmetric key cryptography using a second secret key generated from the second random integer and the first Diffie-Hellman value, generating the second secret key using the first random integer and the second Diffie-Hellman value, and decrypting the encrypted acknowledgement message using the generated second secret key.

According to another embodiment of the present disclosure, a computer program stored in a computer-readable recording medium is combined with hardware to perform steps of receiving, from a first communication device, a first Diffie-Hellman value generated using a first random integer selected by the first communication device, and an certification data encrypted by a symmetric key cryptography using a first secret key generated from the first random integer and a public key of a second communication device, generating the first private key from a private key corresponding to the public key and the first Diffie-Hellman value, decrypting the encrypted certification data using the generated first secret key, certifying the first communication device using the decrypted certification data and generating an acknowledgement message including the certification result, generating a second Diffie-Hellman value using a second random integer, generating a second secret key from the second random integer and the first Diffie-Hellman value, encrypting the acknowledgement message by the symmetric key cryptography using the generated second secret key, and transmitting the second Diffie-Hellman value and the encrypted acknowledgement message to the first communication device.

According to the embodiments of the present disclosure, certification and encryption key exchange are simultaneously performed using a key encapsulation mechanism embedded in a public key based encryption algorithm and a symmetric key based encryption algorithm, thereby simultaneously improving the security of two-way certification and a session key and enabling an efficient encryption key exchange even when a size of data for certification increases.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a block diagram of an encryption key exchange system according to an embodiment of the present disclosure;

FIG. 2 is a block diagram of an encryption key exchange apparatus according to an embodiment of the present disclosure;

FIG. 3 is a detailed block diagram of an encryption unit according to an embodiment of the present disclosure;

FIG. 4 is a detailed block diagram of a decryption unit according to an embodiment of the present disclosure;

FIG. 5 is a block diagram of an encryption key exchange apparatus according to another embodiment of the present disclosure;

FIG. 6 is a detailed block diagram of a decryption unit according to another embodiment of the present disclosure;

FIG. 7 is a detailed block diagram of an encryption unit according to another embodiment of the present disclosure;

FIG. 8 is a flowchart of a method for exchanging an encryption key according to an embodiment of the present disclosure; and

FIG. 9 is a flowchart of a method for exchanging an encryption key according to another embodiment of the present disclosure.

### DETAILED DESCRIPTION OF EXEMPLARY EMBODIMENTS

Hereinafter, detailed embodiments of the present disclosure will be described with reference to the accompanying drawings. The following detailed description is provided in order to assist in a comprehensive understanding of a method, apparatus, and/or system described herein. However, it is merely an example, and the present disclosure is not limited thereto.

In describing the embodiments of the present disclosure, when it is determined that a detailed description of a well-known technology related to the present disclosure can unnecessarily obscure a gist of the present disclosure, the description thereof will be omitted. In addition, terms to be mentioned below are terms defined by considering functions in the present disclosure, and may vary in accordance with intentions or customs of a user or an operator. Therefore, the terms should be defined based on the content throughout this specification. The terms used in the detailed description are only for describing embodiments of the present disclosure, and should not be deemed limiting. Unless clearly used otherwise, a singular expression includes a meaning of a plural expression. In the description, expressions such as “including” or “having” are for indicating certain features, numbers, steps, operations, elements, and a part or combination thereof, and should not be construed as excluding a presence or possibility of one or more other features, numbers, steps, operations, elements, components, and a part or combination thereof.

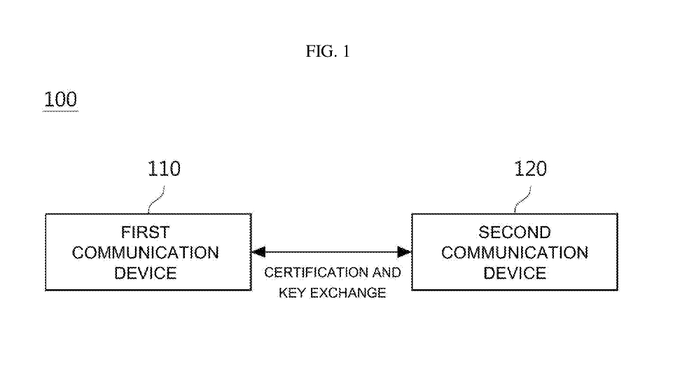

FIG. 1 is a block diagram of an encryption key exchange system according to an embodiment of the present disclosure.

Referring to FIG. 1, an encryption key exchange system 100 according to an embodiment of the present disclosure includes a first communication device 110 and a second communication device 120.

The first communication device 110 and the second communication device 120 are devices for transceiving encrypted data with each other using a wired or wireless network, and may be implemented by various forms of devices such as a personal computer (PC), a tablet PC, a smartphone, a server, etc.

The first communication device 110 may transmit certification data of a user to the second communication device 120 and register the certification data at the second communication device 120. Here, the certification data may include various types of information that may certify the user such as a password, a personal identification number (PIN), fingerprint information, a media access control (MAC) address, etc. Also, according to the embodiment of the present disclosure, the certification data may be registered at the second communication device 120 in various forms of values such as a one-way hash value that may be acknowledged by the second communication device 120.

Meanwhile, the second communication device 120 generates a private key and a public key in accordance with a key generation method of a public key based cryptographic algorithm such as the ElGamal algorithm and the Trapdoor discrete log based ID-based cryptographic algorithm to securely store the private key and disclose the public key to the outside. Here, according to the embodiment, the second communication device 120 may also provide its public key to a separate key generation system to be issued a private key generated by the key generation system.

Then, the first communication device 110 and the second communication device 120 may perform certification and exchange keys with each other using the certification data registered at the second communication device 120, the public key of the second communication device 120, etc. This will be described in detail later.

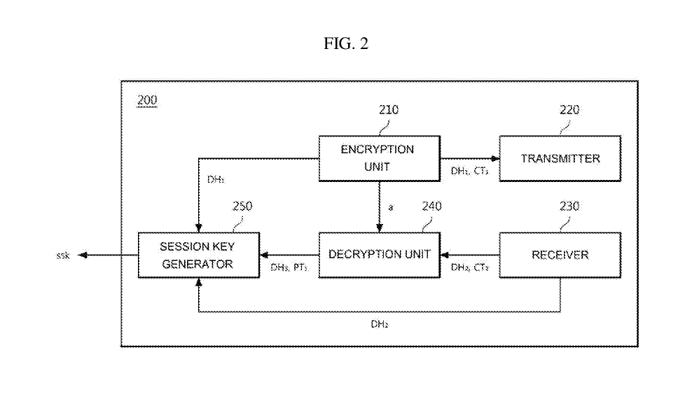

FIG. 2 is a block diagram of an encryption key exchange apparatus 200 according to an embodiment of the present disclosure.

The key exchange apparatus 200 illustrated in FIG. 2 may be, for example, implemented by one configuration included in the first communication device 110 illustrated in FIG. 1.

Referring to FIG. 2, the key exchange apparatus 200 according to an embodiment of the present disclosure includes an encryption unit 210, a transmitter 220, a receiver 230, a decryption unit 240, and a session key generator 250.

The encryption unit 210 generates a public Diffie-Hellman value DH₁ for exchanging an encryption key and a secret key sk₁ for encrypting certification data, and encrypts the certification data using a symmetric key cryptographic algorithm using the generated secret key sk₁.

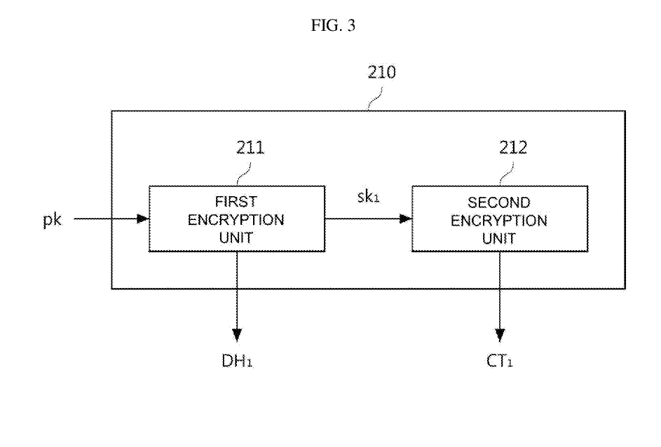

Specifically, FIG. 3 is a detailed block diagram of the encryption unit 210 according to an embodiment of the present disclosure.

Referring to FIG. 3, the encryption unit 210 may include a first encryption unit 211 and a second encryption unit 212.

The first encryption unit 211 may select a random integer a and generate the public Diffie-Hellman value DH₁ and the secret key sk₁ using the selected random integer a and a public key pk disclosed by the second communication device 120.

Here, for the generation of the public Diffie-Hellman value DH₁, various types of probabilistic or randomized public key cryptographic algorithms having a Diffie-Hellman value such as the ElGamal algorithm may be used.

Specifically, the first encryption unit 211 may generate the public Diffie-Hellman value DH₁ using, for example, Equation 1 below.

DH₁=g^{a} mod p [Equation 1]

Here, p represents a large prime number, g represents a generator selected among integers from 1 to p−1, and p and g may be disclosed by the second communication device 120 along with the public key pk or use a value shared in advance between the first communication device 110 and the second communication device 120. Hereinafter, p and g are used as the same meaning.

Meanwhile, the first encryption unit 211 may generate the secret key sk₁ using, for example, Equation 2 below.

sk₂=pk^{a} mod p [Equation 2]

The second encryption unit 212 may encrypt the certification data using the secret key sk₁ generated by the first encryption unit 211. Here, for the generation of encrypted certification data CT₁, various forms of symmetric key cryptographic algorithms such as advanced encryption standard (AES) and data encryption standard (DES), etc. may be used.

Referring again to FIG. 2, the transmitter 220 transmits the public Diffie-Hellman value DH₁ and the encrypted certification data CT₁ generated by the encryption unit 210 to the second communication device 120.

The receiver 230 receives a public Diffie-Hellman value DH₂ and an encrypted acknowledgement message CT₂ generated by the second communication device 120 from the second communication device 120. Here, the public Diffie-Hellman value DH₂ may be a value that is generated using a random integer b selected by the second communication device 120.

For example, the public Diffie-Hellman value DH₂ received from the second communication device 120 may be a value that is generated using Equation 3 below.

DH₂=g^{b} mod p [Equation 3]

In addition, the encrypted acknowledgement message CT₂ may be a message that is encrypted using a symmetric key cryptographic algorithm using a secret key sk₂ induced from the random integer b and the public Diffie-Hellman value DH₁ provided to the second communication device 120.

For example, the secret key sk₂ may be a key that is generated from a private Diffie-Hellman value DH₃ generated using the random integer b and the public Diffie-Hellman value DH₁ provided to the second communication device 120.

Specifically, the private Diffie-Hellman value DH₃ may be a value that is generated using, for example, Equation 4 below.

DH₃=DH₁^{b} mod p=g^{ab} mod p [Equation 4]

In addition, the secret key sk₂ may be a key that is generated by applying a hash function to the private Diffie-Hellman value DH₃ as shown, for example, in Equation 5 below.

sk₂=H(DH₃)=H(g^{ab} mod p) [Equation 5]

Here, H represents a hash function, and is used as the same meaning, hereinafter.

The decryption unit 240 may generate the secret key sk₂ for decrypting the encrypted acknowledgement message using the random integer a selected by the encryption unit 210 and the public Diffie-Hellman value DH₂ received from the second communication device 120, and decrypt the encrypted acknowledgement message CT₂ using the generated secret key sk₂.

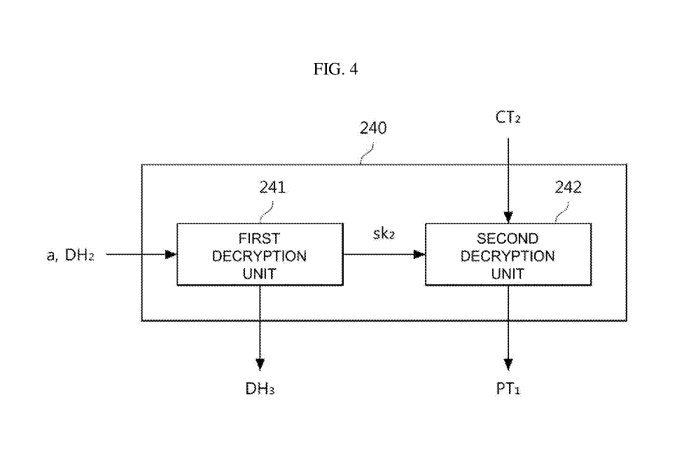

Specifically, referring to FIG. 4, the decryption unit 240 may include a first decryption unit 241 and a second decryption unit 242.

The first decryption unit 241 may generate the private Diffie-Hellman value DH₃ from the public Diffie-Hellman value DH₂ received from the second communication device 120 using the random integer a selected by the encryption unit 210, and generate the secret key sk₂ from the generated private Diffie-Hellman value DH₃.

For example, the first decryption unit 241 may generate the private Diffie-Hellman value DH₃ using Equation 6 below.

DH₃=DH₂^{a} mod p=g^{ab} mod p [Equation 6]

In addition, the first decryption unit 241 may generate the secret key sk₂ using, for example, Equation 5 mentioned above.

The second decryption unit 242 may decrypt the encrypted acknowledgement message CT₂ received from the second communication device 120 using a symmetric key cryptographic algorithm using the secret key sk₂ generated by the first decryption unit 241. The symmetric key cryptographic algorithm used here may be the same algorithm as the one used in the second communication device 120 for generating the encrypted acknowledgement message CT₂.

Again, referring to FIG. 2, the session key generator 250 may verify the legitimacy of an acknowledgement message PT₁ decrypted by the decryption unit 240 and generate a session key ssk.

Here, according to an embodiment of the present disclosure, the session key ssk may be generated from the public Diffie-Hellman value DH₁ generated by the encryption unit 210, the public Diffie-Hellman value DH₂ received from the second communication device 120, the private Diffie-Hellman value DH₃ generated by the decryption unit 240, identification information C of the first communication device 110, and identification information S of the second communication device 120. Here, the identification information C of the first communication device 110 and the identification information S of the second communication device 120 may be various forms of public information such as an ID, an e-mail address, an IP address, a URL address, a homepage address, a business/brand name, a service name etc.

As a detailed example, the session key generator 250 may generate the session key ssk using Equation 7 below.

ssk=H(C,S,DH₁,DH₂,DH₃) [Equation 7]

Meanwhile, the encryption unit 210, the transmitter 220, the receiver 230, the decryption unit 240, the session key generator 250, the first encryption unit 211, the second encryption unit 212, the first decryption unit 241, and the second decryption unit 242 illustrated in FIGS. 2 to 4 may be those classified in accordance with functions performed in the key exchange apparatus 200, and may not be clearly differentiated in terms of specific operations.

In addition, in an embodiment, the encryption unit 210, the transmitter 220, the receiver 230, the decryption unit 240, the session key generator 250, the first encryption unit 211, the second encryption unit 212, the first decryption unit 241, and the second decryption unit 242 illustrated in FIGS. 2 to 4 may be implemented in one or more computing devices including one or more processors and a computer-readable recording medium connected to the one or more processors. The computer-readable recording medium may be placed inside or outside the one or more processors, and may be connected to the one or more processors by various well-known means. The one or more processors in the one or more computing devices may enable each of the computing devices to operate in accordance with exemplary embodiments described herein. For example, the one or more processors may execute a command stored in the computer-readable recording medium, and the command stored in the computer-readable recording medium may be configured to enable the one or more computing devices to perform operations in accordance with an exemplary embodiment described herein when executed by the one or more processors.

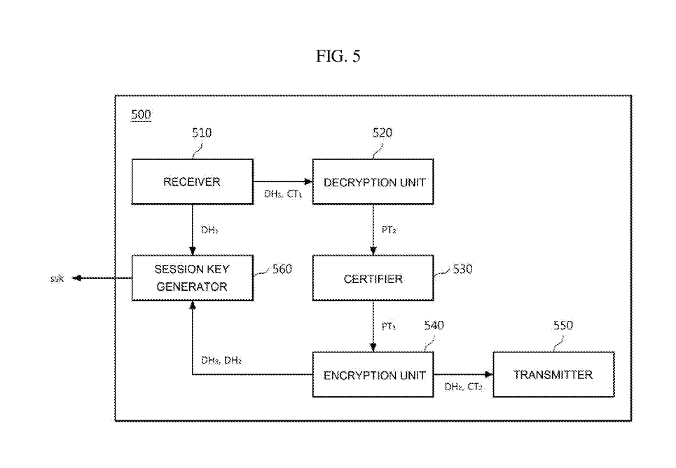

FIG. 5 is a block diagram of an encryption key exchange apparatus according to another embodiment of the present disclosure.

A key exchange apparatus 500 illustrated in FIG. 5 may be, for example, implemented by one configuration included in the second communication device 120 illustrated in FIG. 1.

Referring to FIG. 5, the key exchange apparatus 500 according to an embodiment of the present disclosure includes a receiver 510, a decryption unit 520, a certifier 530, an encryption unit 540, a transmitter 550, and a session key generator 560.

The receiver 510 receives the encrypted certification data CT₁ and the public Diffie-Hellman value DH₁ from the first communication device 110.

According to an embodiment of the present disclosure, the public Diffie-Hellman value DH₁ received from the first communication device 110 may be a value that is generated using the random integer a selected by the first communication device 110. As a detailed example, the public Diffie-Hellman value DH₁ may be a value that is generated in accordance with Equation 1 mentioned above.

In addition, according to an embodiment of the present disclosure, the encrypted certification data CT₁ received from the first communication device 110 may be data that is encrypted using the symmetric key cryptographic algorithm using the secret key sk₁ generated using the public key pk disclosed by the second communication device 120 and the random integer a selected by the first communication device 110. As a detailed example, the secret key sk₁ may be a key that is generated in accordance with Equation 2 mentioned above.

The decryption unit 520 generates the secret key sk₁ for the decryption of the encrypted certification data CT₁ using the public Diffie-Hellman value DH₁ received from the first communication device 110, and decrypts the encrypted certification data CT₁ using the symmetric key cryptographic algorithm using the generated secret key sk₁.

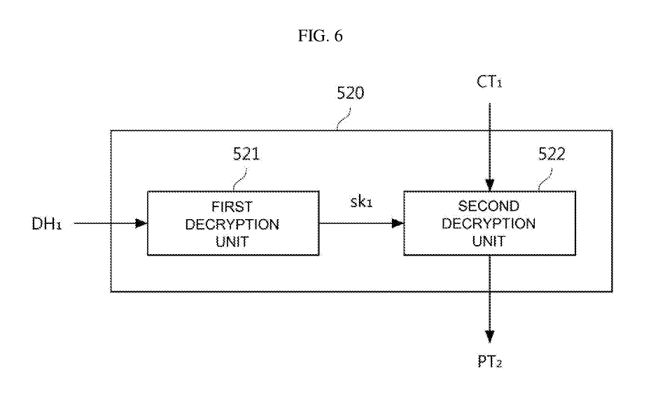

Specifically, FIG. 6 is a detailed block diagram of the decryption unit 520 according to another embodiment of the present disclosure.

Referring to FIG. 6, the decryption unit 520 may include a first decryption unit 521 and a second decryption unit 522.

The first decryption unit 521 may generate the secret key sk₁ for decrypting the encrypted certification data CT₁ using the public Diffie-Hellman value DH₁ received from the first communication device 110 and a private key x corresponding to the public key pk of the second communication device 120.

Specifically, the first decryption unit 521 may generate the secret key sk₁ using, for example, Equation 8 below.

sk₁=DH₁^{x} mod p=g^{ax} mod p [Equation 8]

Meanwhile, the second decryption unit 522 may decrypt the encrypted certification data CT₁ using the secret key sk₁ generated by the first decryption unit 521. The symmetric key cryptographic algorithm used here may be the same algorithm as the one used in the first communication device 110 for the encryption of the certification data.

Referring again to FIG. 5, the certifier 530 may verify the legitimacy of certification data by comparing certification data PT₂ decrypted by the decryption unit 520 with preregistered certification data of the first communication device 110, and generate the acknowledgement message PT₁ including the result thereof.

The encryption unit 540 generates the public Diffie-Hellman value DH₂ for exchanging an encryption key and the secret key sk₂ for encrypting the acknowledgement message, and encrypts the acknowledgement message PT₁ using the symmetric key cryptographic algorithm using the generated secret key sk₂.

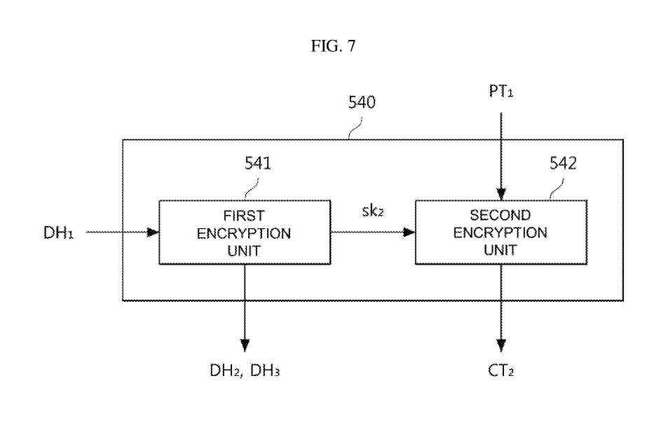

Specifically, referring to FIG. 7, the encryption unit 540 may include a first encryption unit 541 and a second encryption unit 542.

The first encryption unit 541 may generate the public Diffie-Hellman value DH₂ by selecting the random integer b, and may generate the secret key sk₂ for the encryption of the acknowledgement message using the random integer b and the public Diffie-Hellman value DH₁ received from the first communication device 110.

Specifically, according to an embodiment of the present disclosure, the first encryption unit 541 may select the random integer b, and then generate the public Diffie-Hellman value DH₂ using, for example, Equation 9 below.

DH₂=g^{b} mod p [Equation 9]

In addition, according to an embodiment of the present disclosure, the first encryption unit 541 may generate the private Diffie-Hellman value DH₃ using the selected random integer b and the public Diffie-Hellman value DH₁ received from the first communication device 110, and induce the secret key sk₂ for encrypting the acknowledgement message from the private Diffie-Hellman value DH₃.

For example, the first encryption unit 541 may generate the private Diffie-Hellman value DH₃ using Equation 10 below.

DH₃=DH₁^{b} mod p=g^{ab} mod p [Equation 10]

In addition, the first encryption unit 541 may generate the secret key sk₂ for encrypting the acknowledgement message by applying a hash function to the private Diffie-Hellman value DH₃ as shown in Equation 11 below.

sk₂=H(DH₃)=H(g^{ab} mod p) [Equation 11]

The second encryption unit 542 may encrypt the acknowledgement message using the symmetric key cryptographic algorithm using the secret key sk₂ generated by the first encryption unit 541.

Referring again to FIG. 5, the transmitter 550 transmits the public Diffie-Hellman value DH₂ generated by the encryption unit 540 and an encrypted acknowledgement message CT₂ to the first communication device 110.

The session key generator 560 may generate the session key ssk from the public Diffie-Hellman value DH₁ received from the first communication device 110, the public Diffie-Hellman value DH₂ and the private Diffie-Hellman value DH₃ generated by the encryption unit 540, the identification information C of the first communication device 110, and the identification information S of the second communication device 120. Here, the identification information C of the first communication device 110 and the identification information S of the second communication device 120 may be various forms of public information such as an ID, an e-mail address, an IP address, a URL address, a homepage address, a business/brand name, a service name etc. Also, the session key ssk may be generated using, for example, Equation 7 mentioned above.

Meanwhile, the receiver 510, the decryption unit 520, the certifier 530, the encryption unit 540, the transmitter 550, the session key generator 560, the first decryption unit 521, the second decryption unit 522, the first encryption unit 541, and the second encryption unit 542 illustrated in FIGS. 5 to 7 may be those classified in accordance with functions performed in the key exchange apparatus 500, and may not be clearly differentiated in terms of specific operations.

In addition, in an embodiment, the receiver 510, the decryption unit 520, the certifier 530, the encryption unit 540, the transmitter 550, the session key generator 560, the first decryption unit 521, the second decryption unit 522, the first encryption unit 541, and the second encryption unit 542 illustrated in FIGS. 5 to 7 may be implemented in one or more computing devices including one or more processors and a computer-readable recording medium connected to the one or more processors. The computer-readable recording medium may be placed inside or outside the one or more processors, and may be connected to the one or more processors by various well-known means. The one or more processors in the one or more computing devices may enable each of the computing devices to operate in accordance with exemplary embodiments described herein. For example, the one or more processors may execute a command stored in the computer-readable recording medium, and the command stored in the computer-readable recording medium may be configured to enable the one or more computing devices to perform operations in accordance with an exemplary embodiment described herein when executed by the one or more processors.

Hereinafter, an operation of the key exchange system 100 according to an exemplary embodiment of the present disclosure will be described in more detail. Meanwhile, the key exchange system 100 is assumed to be a server-client model in the embodiment to be described below, and the description is given based on assumptions that the first communication device 110 is a client and the second communication device 120 is a server, but this is only for convenience of the description, and it should be noted that various forms of two-way key exchange systems other than the server-client model may be applied.

Example using the ElGamal algorithm and the AES algorithm

[Setup]

Client: A client selects his or her certification information (e.g., a password, etc.) and registers the information at a server.

Server: The server uses a private key y to generate a public key Y=g^{y} mod p, and discloses the generated public key to the outside.

[Encryption Key Exchange]

Client

1) The client selects a random integer a, and generates a public Diffie-Hellman value DH₁=g^{a} mod p and a secret key sk₁=y^{a} mod p=g^{ay} mod p.

2) The client generates encrypted certification data CT₁ by using the generated secret key sk₁ as a key of the AES algorithm.

3) The client transmits the generated public Diffie-Hellman value DH₁ and the encrypted certification data CT₁ to the server.

Server

1) The server generates the secret key sk₁ by calculating sk₁=DH₁^{y} mod p=g^{ay} mod p from the private key y and the received public Diffie-Hellman value DH₁.

2) The server decrypts the encrypted certification data CT₁, by using the generated secret key sk₁ as the key of the AES algorithm.

3) The server certifies the client using the decrypted certification data and the preregistered certification information of the client, and generates an acknowledgement message including the certification result.

4) The server selects a random integer b, and generates a public Diffie-Hellman value DH₂=g^{b} mod p and a private Diffie-Hellman value DH₃=DH₁^{b} mod p=g^{ab} mod p.

5) The server generates a secret key sk₂=H(DH₃) from the private Diffie-Hellman value DH₃, and generates an encrypted acknowledgement message CT₂ by using the generated secret key sk₂ as the key of the AES algorithm.

6) The server transmits the generated public Diffie-Hellman value DH₂ and the encrypted acknowledgement message CT₂ to the client.

Client

1) The client generates the private Diffie-Hellman value DH₃=DH₂^{a} mod p=g^{ab} mod p by using the public Diffie-Hellman value DH₂ received from the server and the random integer a used when generating the public Diffie-Hellman value DH₁.

2) The client generates the secret key sk₂=H(DH₃) from the generated private Diffie-Hellman value DH₃, decrypts the encrypted acknowledgement message CT₂ by using the generated secret key sk₂ as the key of the AES algorithm, and verifies the legitimacy of the decrypted acknowledgement message.

[Session Key Generation]

The client and the server each generate a session key ssk=H(C, S, DH₁, DH₂, DH₃) using identification information C of the client, identification information S of the server, and the Diffie-Hellman values DH₁, DH₂, and DH₃.

Example using the trapdoor discrete log group based ID-based cryptographic algorithm and the AES algorithm

[Setup]

Client: A client selects his or her certification information (e.g., a password, etc.) and registers the information at a server.

Server: The server sets an ID IDs which is the server's public key to generate a private key Ks=log_{g}H(IDs) corresponding to the IDs, and discloses the public key IDs to the outside.

[Key Exchange]

Client

1) The client selects a random integer a, and generates a public Diffie-Hellman value DH₁=g^{a} mod p and a secret key sk₁=[H(IDs)]^{a} mod p.

2) The client generates encrypted certification data CT₁ by using the generated secret key sk₁ as a key of the AES algorithm.

3) The client transmits the generated public Diffie-Hellman value DH₁ and the encrypted certification data CT₁ to the server.

Server

1) The server generates the secret key sk₁ by calculating sk₁=DH₁^{Ks} mod p=g^{aKs} mod p.

2) The server decrypts the encrypted certification data CT₁ by using the generated secret key sk₁ as the key of the AES algorithm.

3) The server certifies the client using the decrypted certification data and the preregistered certification information of the client, and generates an acknowledgement message including the certification result.

4) The server selects a random integer b, and generates a public Diffie-Hellman value DH₂=g^{b} mod p and a private Diffie-Hellman value DH₃=DH₁^{b} mod p=g^{ab} mod p.

5) The server generates a secret key sk₂=H(DH₃) from the private Diffie-Hellman value DH₃, and generates an encrypted acknowledgement message CT₂ By using the generated secret key sk₂ as the key of the AES algorithm.

6) The server transmits the generated public Diffie-Hellman value DH₂ and the encrypted acknowledgement message CT₂ to the client.

Client

1) The client generates the private Diffie-Hellman value DH₃=DH₂^{a} mod p=g^{ab} mod p by using the public Diffie-Hellman value DH₂ received from the server and the random integer a used when generating the public Diffie-Hellman value DH₁.

2) The client generates the secret key sk₂=H(DH₃) from the generated private Diffie-Hellman value DH₃, decrypts the encrypted acknowledgement message CT₂ by using the generated secret key sk₂ as the key of the AES algorithm, and verifies the legitimacy of the decrypted acknowledgement message.

[Session Key Generation]

The client and the server each generate a session key ssk=H(C, S, DH₁, DH₂, DH₃) using identification information C of the client, identification information S of the server, and the Diffie-Hellman values DH₁, DH₂, and DH₃.

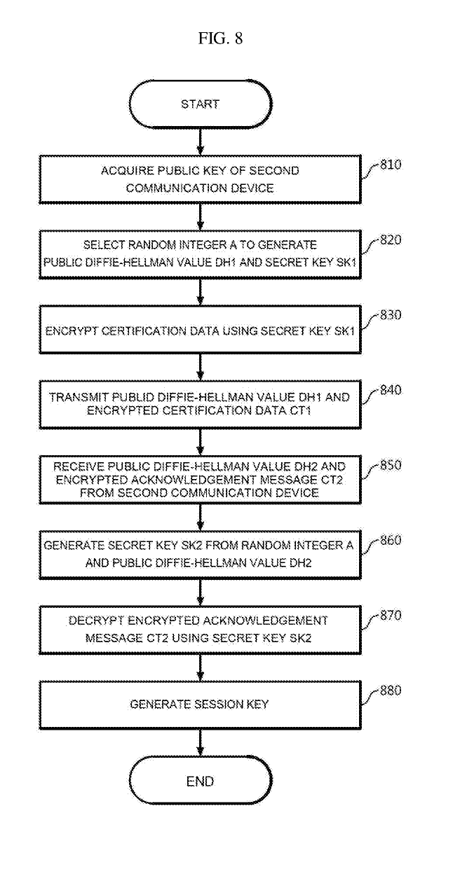

FIG. 8 is a flowchart of a method for exchanging an encryption key according to an embodiment of the present disclosure.

The method illustrated in FIG. 8 may be performed, for example, by the key exchange apparatus 200 illustrated in FIG. 2.

Referring to FIG. 8, the key exchange apparatus 200 acquires a public key disclosed by the second communication device 120 (S810).

Then, the key exchange apparatus 200 selects a random integer a to generate a public Diffie-Hellman value DH₁ and a secret key sk₁ (S820).

Here, according to an embodiment of the present disclosure, the key exchange apparatus 200 may select the random integer a to generate the public Diffie-Hellman value DH₁ from the selected random integer a, and generate the secret key sk₁ from the public key of the second communication device 120.

Then, the key exchange apparatus 200 uses the generated secret key sk₁ to encrypt certification data by the symmetric key cryptography (S830).

Then, the key exchange apparatus 200 transmits the public Diffie-Hellman value DH₁ and encrypted certification data CT₁ to the second communication device 120 (S840).

Then, the key exchange apparatus 200 receives a public Diffie-Hellman value DH₂ and an encrypted acknowledgement message CT₂ from the second communication device 120 (S850).

Here, according to an embodiment of the present disclosure, the public Diffie-Hellman value DH₂ may be a value that is generated from a random integer b selected by the second communication device 120.

In addition, according to an embodiment of the present disclosure, the encrypted acknowledgement message CT₂ may be a message that is encrypted by the symmetric key cryptography using a secret key sk₂ induced from a private Diffie-Hellman value DH₃ generated using the random integer b selected by the second communication device 120 and the public Diffie-Hellman value DH₁.

Then, the key exchange apparatus 200 generates the secret key sk2 from the random integer a and the received public Diffie-Hellman value DH₂ (S860).

Here, according to an embodiment of the present disclosure, the key exchange apparatus 200 may generate the private Diffie-Hellman value DH₃ using the random integer a and the received public Diffie-Hellman value DH₂, and generate the secret key sk2 from the private Diffie-Hellman value DH₃.

Then, the key exchange apparatus 200 verifies the legitimacy of the encrypted acknowledgement message CT₂ by decrypting the encrypted acknowledgement message CT₂ using the generated secret key sk₂ (S870).

Then, the key exchange apparatus 200 generates a session key ssk using identification information of the first communication device 110, identification information of the second communication device 120, the public Diffie-Hellman values DH₁ and DH₂, and the private Diffie-Hellman value DH₃ (S880).

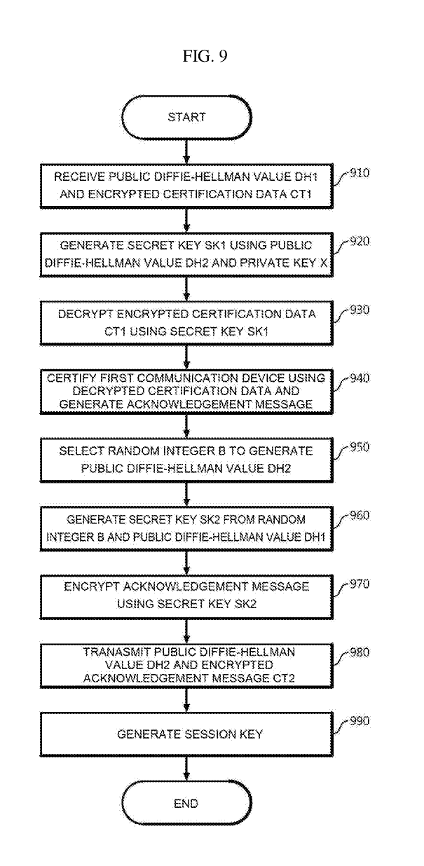

FIG. 9 is a flowchart of a method for exchanging an encryption key according to another embodiment of the present disclosure.

The method illustrated in FIG. 9 may be performed, for example, by the key exchange apparatus 500 illustrated in FIG. 5.

Referring to FIG. 9, the key exchange apparatus 500 receives a public Diffie-Hellman value DH₁ and an encrypted certification data CT₁ from the first communication device 110 (S910).

Here, according to an embodiment of the present disclosure, the public Diffie-Hellman value DH₁ may be a value that is generated from a random integer a selected by the first communication device 110.

In addition, according to an embodiment of the present disclosure, the encrypted certification data CT₁ may be data that is encrypted by the symmetric key cryptography using the random integer a selected by the first communication device 110 and a secret key sk₁ induced from a public key disclosed by the second communication device 120.

Then, the key exchange apparatus 500 generates the secret key sk₁ using a private key corresponding to the public key of the second communication device 120 and the received public Diffie-Hellman value DH₁ (S920).

Then, the key exchange apparatus 500 decrypts the certification data CT₁ encrypted by the symmetric key cryptography using the generated secret key sk₁ (S930).

Then, the key exchange apparatus 500 certifies the first communication device 110 using the decrypted certification data, and generates an acknowledgement message including the result thereof (S940).

Then, the key exchange apparatus 500 selects a random integer b to generate a public Diffie-Hellman value DH₂ (S950).

Then, the key exchange apparatus 500 generates a secret key sk2 from the selected random integer b and the public Diffie-Hellman value DH₁ received from the first communication device (S960).

Here, according to an embodiment of the present disclosure, the key exchange apparatus 500 may generate a private Diffie-Hellman value DH₃ using the random integer b and the received public Diffie-Hellman value DH₁, and generate a secret key sk₂ from the private Diffie-Hellman value DH₃.

Then, the key exchange apparatus 500 encrypts the acknowledgement message by the symmetric key cryptography using the generated secret key sk₂ (S970).

Then, the key exchange apparatus 500 transmits the generated public Diffie-Hellman value DH₂ and an encrypted acknowledgement message CT₂ to the first communication device 110 (S980).

Then, the key exchange apparatus 500 generates a session key ssk using identification information of the first communication device 110, identification information of the second communication device 120, the public Diffie-Hellman values DH₁ and DH₂, and the private Diffie-Hellman value DH₃ (S990).

Meanwhile, although the methods have been divided into a plurality of steps in the flowcharts illustrated in FIGS. 8 and 9, at least some of the steps may be performed in a different order, combined with another step and performed together, omitted, performed by being divided into specific steps, or performed by having one or more unillustrated steps added thereto.

Meanwhile, the embodiment of the present disclosure may include a computer-readable recording medium that includes a program for performing the methods described herein in a computer. The computer-readable recording medium may include a program command, a local data file, a local data structure, etc. solely or in combinations thereof. The medium may be one particularly designed and configured for the present disclosure, or one that may be generally used in the computer software field. Examples of the computer-readable recording medium include hardware devices particularly configured to store and execute a program command including magnetic media such as a hard disk, a floppy disk, and a magnetic tape, an optical recording medium such as a CD-ROM and a DVD, a magnetic-optical medium such as a floppy disk, a read-only memory (ROM), a random-access memory (RAM), and a flash memory. Examples of the program command may not only include machine codes formed by a compiler but also a high-level language code that may be executed by a computer using an interpreter, etc.

Although typical embodiments of the present disclosure have been described in detail, those of ordinary skill in the art to which the present disclosure pertains will understand that the above-mentioned embodiments may be modified in various ways without departing from the scope of the present disclosure. Therefore, the scope of the present disclosure should not be defined by being limited to the described embodiments, and should be defined not only by the claims below but also by the equivalents of the claims.

What is claimed is:

1. An encryption key exchange apparatus included in a first communication device to perform a key exchange between the first communication device and a second communication device, the apparatus comprising:
an encryption unit configured to generate a first Diffie-Hellman value and a first secret key based on a first random integer and a public key of the second communication device, and configured to encrypt certification data by a symmetric key cryptography based on the first secret key;
a transmitter configured to transmit the first Diffie-Hellman value and the encrypted certification data to the second communication device;
a receiver configured to receive, from the second communication device, a second Diffie-Hellman value generated based on a second random integer selected by the second communication device, and configured to receive an acknowledgement message encrypted by the symmetric key cryptography based on a second secret key generated based on the second random integer and the first Diffie-Hellman value; and
a decryption unit configured to generate the second secret key based on the first random integer and the second Diffie-Hellman value and configured to decrypt the encrypted acknowledgement message based on the generated second secret key.

2. The encryption key exchange apparatus according to claim 1, wherein the encryption unit is configured to generate the first Diffie-Hellman value based on the first random integer, and configured to generate the first secret key based on the first random integer and the public key of the second communication device.

3. The encryption key exchange apparatus according to claim 1, wherein the encrypted acknowledgement message is encrypted based on the second secret key generated based on a third Diffie-Hellman value,
wherein the third Diffie-Hellman value is generated based on the second random integer and the first Diffie-Hellman value.

4. The encryption key exchange apparatus according to claim 3, wherein the decryption unit is configured to generate the third Diffie-Hellman value based on the first random integer and the second Diffie-Hellman value, and configured to generate the second secret key based on the third Diffie-Hellman value.

5. The encryption key exchange apparatus according to claim 4, further comprising a session key generator configured to verify a legitimacy of the decrypted acknowledgement message and configured to generate a session key based on the first Diffie-Hellman value, the second Diffie-Hellman value, and the third Diffie-Hellman value.

6. A method for exchanging an encryption key of a first communication device that performs a key exchange with a second communication device, the method comprising:
generating a first Diffie-Hellman value and a first secret key based on a first random integer and a public key of the second communication device;
encrypting certification data by a symmetric key cryptography based on the first secret key;
transmitting the first Diffie-Hellman value and the encrypted certification data to the second communication device;
receiving, from the second communication device, a second Diffie-Hellman value generated based on a second random integer selected by the second communication device, and an acknowledgement message encrypted by the symmetric key cryptography based on a second secret key generated based on the second random integer and the first Diffie-Hellman value;
generating the second secret key based on the first random integer and the second Diffie-Hellman value; and
decrypting the encrypted acknowledgement message based on the generated second secret key.

7. The method according to claim 6, wherein the encrypting comprises:
generating the first Diffie-Hellman value based on the first random integer;
generating the first secret key based on the first random integer and the public key of the second communication device; and
encrypting the certification data by the symmetric key cryptography based on the first secret key.

8. The method according to claim 6, wherein the encrypted acknowledgement message is encrypted based on the second secret key generated based on a third Diffie-Hellman value,
wherein the third Diffie-Hellman is generated based on the second random integer and the first Diffie-Hellman value.

9. The method according to claim 8, wherein the decrypting comprises:
generating the third Diffie-Hellman value based on the first random integer and the second Diffie-Hellman value;
generating the second secret key based on the third Diffie-Hellman value; and
decrypting the encrypted acknowledgement message based on the second secret key.

10. The method according to claim 9, further comprising:
verifying a legitimacy of the decrypted acknowledgement message; and
generating a session key based on the first Diffie-Hellman value, the second Diffie-Hellman value, and the third Diffie-Hellman value.

11. An encryption key exchange apparatus included in a second communication device to perform a key exchange between a first communication device and the second communication device, the apparatus comprising:
a receiver configured to receive, from the first communication device, a first Diffie-Hellman value generated based on a first random integer selected by the first communication device, and configured to receive an certification data encrypted by a symmetric key cryptography based on a first secret key generated from the first random integer and a public key of the second communication device;
a decryption unit configured to generate the first secret key from a private key corresponding to the public key and the first Diffie-Hellman value, and configured to decrypt the encrypted certification data based on the generated first secret key;
a certifier configured to certify the first communication device based on the decrypted certification data, and configured to generate an acknowledgement message comprising the certification result;
an encryption unit configured to generate a second Diffie-Hellman value based on a second random integer, and to generate a second secret key based on the second random integer and the first Diffie-Hellman value, and configured to encrypt the acknowledgement message by the symmetric key cryptography based on the generated second secret key; and
a transmitter configured to transmit the second Diffie-Hellman value and the encrypted acknowledgement message to the first communication device.

12. The apparatus according to claim 11, wherein the encryption unit is configured to generate a third Diffie-Hellman value based on the second random integer and the first Diffie-Hellman value, and configured to generate the second secret key based on the third Diffie-Hellman value.

13. The apparatus according to claim 12, further comprising a session key generator configured to generate a session key based on the first Diffie-Hellman value, the second Diffie-Hellman value, and the third Diffie-Hellman value.

14. A method for exchanging an encryption key of a second communication device that performs a key exchange with a first communication device, the method comprising:
receiving, from the first communication device, a first Diffie-Hellman value generated based on a first random integer selected by the first communication device, and an certification data encrypted by a symmetric key cryptography based on a first secret key generated from the first random integer and a public key of the second communication device;
generating the first secret key from a private key corresponding to the public key and the first Diffie-Hellman value;
decrypting the encrypted certification data based on the generated first secret key;
certifying the first communication device based on the decrypted certification data and generating an acknowledgement message comprising the certification result;
generating a second Diffie-Hellman value based on a second random integer;
generating a second secret key based on the second random integer and the first Diffie-Hellman value;
encrypting the acknowledgement message by the symmetric key cryptography based on the generated second secret key; and
transmitting the second Diffie-Hellman value and the encrypted acknowledgement message to the first communication device.

15. The method according to claim 14, wherein the generating of the second secret key comprises:
generating a third Diffie-Hellman value based on the second random integer and the first Diffie-Hellman value; and
generating the second secret key based on the third Diffie-Hellman value.

16. The method according to claim 15, further comprising generating a session key based on the first Diffie-Hellman value, the second Diffie-Hellman value and the third Diffie-Hellman value.

17. A non-transitory computer-readable recording medium that stores a program that causes a computer to execute a method comprising:
generating a first Diffie-Hellman value and a first secret key based on a first random integer and a public key of a second communication device;
encrypting certification data by a symmetric key cryptography based on the first secret key;
transmitting the first Diffie-Hellman value and the encrypted certification data to the second communication device;
receiving, from the second communication device, a second Diffie-Hellman value generated based on a second random integer selected by the second communication device, and an acknowledgement message encrypted by the symmetric key cryptography based on a second secret key generated based on the second random integer and the first Diffie-Hellman value;
generating the second secret key based on the first random integer and the second Diffie-Hellman value; and
decrypting the encrypted acknowledgement message using the generated second secret key.

18. A non-transitory computer-readable recording medium that stores a program that causes a computer to execute a method comprising:
receiving, from a first communication device, a first Diffie-Hellman value generated based on a first random integer selected by the first communication device, and an certification data encrypted by a symmetric key cryptography based on a first secret key generated based on the first random integer and a public key of the second communication device;
generating the first secret key from a private key corresponding to the public key and the first Diffie-Hellman value;
decrypting the encrypted certification data based on the generated first secret key;
certifying the first communication device based on the decrypted certification data and generating an acknowledgement message comprising the certification result;
generating a second Diffie-Hellman value based on a second random integer;
generating a second secret key based on the second random integer and the first Diffie-Hellman value;
encrypting the acknowledgement message by the symmetric key cryptography based on the generated second secret key; and
transmitting the second Diffie-Hellman value and the encrypted acknowledgement message to the first communication device.
